(19) United States
(12) Patent Application Publication
(10) Pub. No.: US 2008/0275878 A1
(43) Pub. Date: Nov. 6, 2008

(54) METHOD OF MANAGING USER DATA IN COMMUNICATION TERMINAL

(75) Inventors: Jung Hun Kim, Busan Metropolitan City (KR); Young Ho Rhee, Seoul (KR); Jae Hwan Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/115,241

(22) Filed: May 5, 2008

(30) Foreign Application Priority Data
May 4, 2007 (KR) 2007-43600

(51) Int. Cl. G06F 7/00; G06F 17/30

(52) U.S. Cl. 707/7; 707/E17.009

(57) ABSTRACT

A method of managing user data in a communication terminal is provided. The method of managing user data in a communication terminal includes retrieving, when a request for displaying user data is input, in the communication terminal user data generated at a specific date; classifying the user data according to at least two conditions; and displaying a plurality of user data lists for integrally displaying the classified user data on a plurality of display windows on a screen. Therefore, a user of a communication terminal can check user data generated in units of a day, and can easily search for user data in a user data list classified according to various conditions.

### CLAIMS OF PRIORITY

This application claims priority under 35 U.S.C. § 119(a) to a patent application filed in the Korean Intellectual Property Office on May 4, 2007 and assigned Serial No. 2007-43600, the contents of which are hereby incorporated by reference.

### BACKGROUND OF THE INVENTION

1. Field of the Invention

The present invention relates to a method of managing user data in a communication terminal, and more particularly, to a method of managing user data in units of a day in a communication terminal.

2. Description of the Related Art

Nowadays, a communication terminal has various additional functions in addition to a communication function. The communication terminal has various functions available by user request and stores much data. The data stored in the communication terminal includes user data that can be searched according to a user request.

However, upon searching for user data in the communication terminal, a user of the communication terminal should search for user data after entering a menu divided according to an item of user data. The communication terminal aligns the corresponding user data in each menu only in an order of timepoint of generation of the data. Accordingly, it is not easy for the user of the communication terminal to search for desired user data.

### SUMMARY OF THE INVENTION

An aspect of the present application is to solve at least the above problems and/or disadvantages and to provide at least the advantages below. Accordingly, an aspect of the present invention is to provide a method of managing user data that can easily search for user data in a communication terminal.

Another aspect of the present invention is to provide a method of managing user data that can retrieve user data generated at a specific date when a request for displaying the user data is input in a communication terminal.

A further aspect of the present invention is to provide a method of managing user data that can classify user data according to at least two conditions in a communication terminal.

A further aspect of the present invention is to provide a method of managing user data that can display a user data list for integrally displaying user data in a communication terminal on at least two display windows displayed on a screen according to a condition.

According to one aspect of the present application, there is provided a method including retrieving, when a request for displaying user data is input, user data generated at a specific date; classifying the retrieved user data in accordance with multiple associated conditions; and displaying a plurality of user data lists for displaying the classified user data on a plurality of display windows or a plurality of parts of a display window on a screen.

According to another aspect of the present invention, there is provided a method including retrieving, when a request for displaying user data is input, user data generated at a specific date; classifying the retrieved user data according to other party related to each user data, a data item corresponding to each user data, and a sequential timepoint at which each user data is generated; and displaying a list of other parties on a first display window, displaying a list of data items on a second display window, and displaying the user data on a third display window in a time order of a generation time point.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating a configuration of a system for managing user data according to an embodiment of the present invention;

FIG. 2 is a flowchart illustrating a method of managing user data according to an embodiment of the present invention;

FIGS. 3A to 3E are examples of screens displayed upon performing the method of FIG. 2;

FIG. 4 is a flowchart illustrating another method of managing user data according to another embodiment of the present invention; and

FIGS. 5A to 5C are examples of screens displayed upon performing the method of FIG. 4.

### DETAILED DESCRIPTION OF THE PREFERRED EMBODIMENTS

Preferred embodiments of the present invention will now be described with reference to the accompanying drawings in detail. The same reference numbers are used throughout the drawings to refer to the same or like parts. In the following description, a detailed description of known functions and configurations incorporated herein has been omitted for clarity and conciseness.

In the following description, a term “user data” indicates data to be transmitted and received in a communication terminal and data set to the communication terminal by a user. The user data may be a call, message, E-mail, MP3 file, image, schedule, alarm, and user diary. A term “user data list” indicates a list in which user data are registered in order to display the user data. The user data list can be composed in different forms according to a classification condition of user data. For example, the user data list may be composed according to a list of other party related to each user data, or according to a list of data items corresponding to each user data. A term “user data table” indicates a table displaying information of selected user data in a state where a user data list is displayed. The user data table aligns information of the selected user data in a generation timepoint order of each user data.

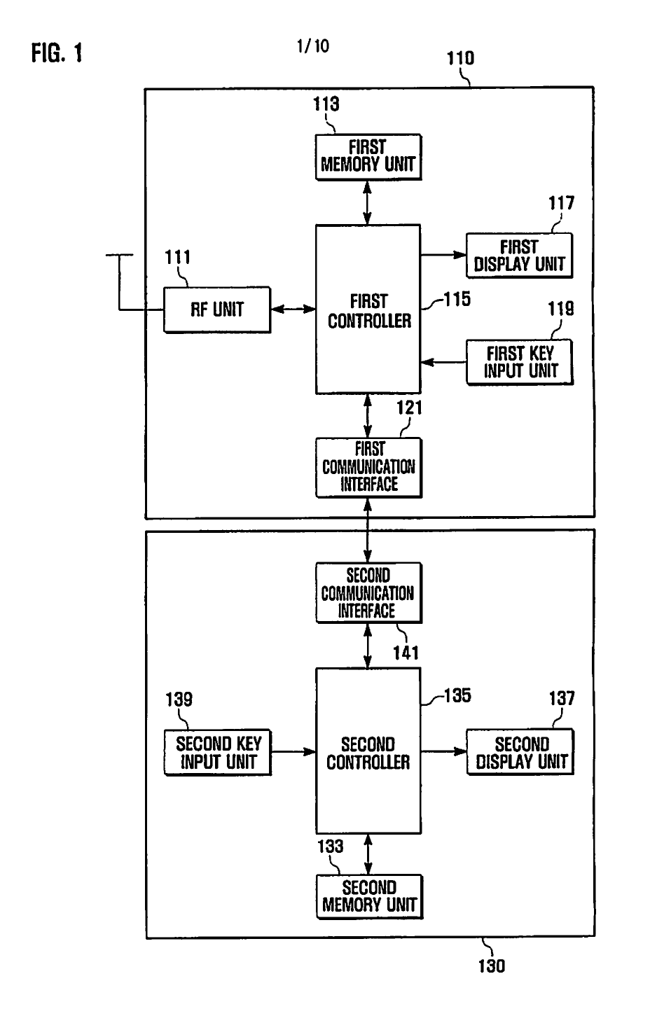

FIG. 1 is a block diagram illustrating a configuration of a system for managing user data according to an embodiment of the present invention.

In the embodiment according to the present invention, the system for managing user data includes a first terminal and a second terminal. It is assumed that the first terminal is a mobile terminal, and the second terminal is a personal computer (PC).

Referring to FIG. 1, a system for managing user data includes a first terminal 110 and a second terminal 130. The first terminal 110 is a terminal in which user data are generated and stored. The first terminal 110 retrieves and displays user data requested by a user. The second terminal 130 retrieves and displays user data transferred from the first terminal 110 that is requested by the user.

The first terminal 110 includes a radio frequency (RF) unit 111, a first memory unit 113, a first controller 115, a first display unit 117, a first key input unit 119, and a first communication interface 121.

The RF unit 111 performs a wireless communication function of the first terminal 110. The RF unit 111 includes an RF transmitter for up-converting a frequency of a signal to be transmitted and amplifying the signal, and an RF receiver for low-noise amplifying a received signal and down-converting a frequency of the signal.

The first memory unit 113 includes a program memory and a data memory. The program memory stores an operation program of the first terminal 110 and a program for managing user data according to the present invention. The data memory stores data generated while performing the program. The first memory unit 113 stores user data generated in the first terminal 110.

The first controller 115 controls general operations of the first terminal 110. The first controller 115 includes a data processor for encoding and modulating a signal to be transmitted and for demodulating and decoding the received signal. The data processor includes a modem and a codec. The codec includes a data codec for processing packet data and an audio codec for processing an audio signal such as a sound. Further, when user data are generated, the first controller 115 stores the generated user data in the first memory unit 113.

When a request for displaying user data is input in the first terminal 110, the first controller 115 extracts and retrieves user data generated at a specific date in the first memory unit 113. The first controller 115 classifies user data according to at least two conditions. Further, the first controller 115 displays a plurality of user data lists on a plurality of display windows on a screen.

The first controller 115 extracts, upon receiving a user request for user data from the second terminal 130, user data generated at a specific date from the first memory unit 113. The first controller 115 transmits the extracted user data to the second terminal 130.

The first display unit 117 displays a state of the first terminal 110 by the control of the first controller 115. The first display unit 117 can use a Liquid Crystal Display (LCD), and in this case, the first display unit 117 includes an LCD controller, a memory for storing display data, and a LCD display element. If the LCD includes a touch screen, the LCD may be operated as an input unit. When a request for displaying user data is input by the user in the first terminal 110, the first display unit 117 displays at least two display windows in which lists of user data are displayed.

The first key input unit 119 includes keys for inputting numeral and character information and function keys for setting various functions.

The first communication interface 121 performs communication with the second terminal 130. The first communication interface 121 receives a request for transmitting user data generated at a specific date from the second terminal 130. The first communication interface 121 transmits user data corresponding to the request of the second terminal 130 to the second terminal 130.

The second terminal 130 includes a second memory unit 133, second controller 135, second display unit 137, second key input unit 139, and second communication interface 141. A configuration of the second terminal 130 in the present embodiment is similar to that of the first terminal 110, and therefore a detailed description thereof is omitted. The second terminal 130 may omit an RF unit.

The first communication interface 121 and the second communication interface 141 are connected to each other by a wired method using, for example, a Universal Serial Bus (USB) and Institute of Electrical and Electronics Engineers 1394 (IEEE 1394) standard or by a wireless method using, for example, Bluetooth® and Infrared Data Association (IrDA) standard.

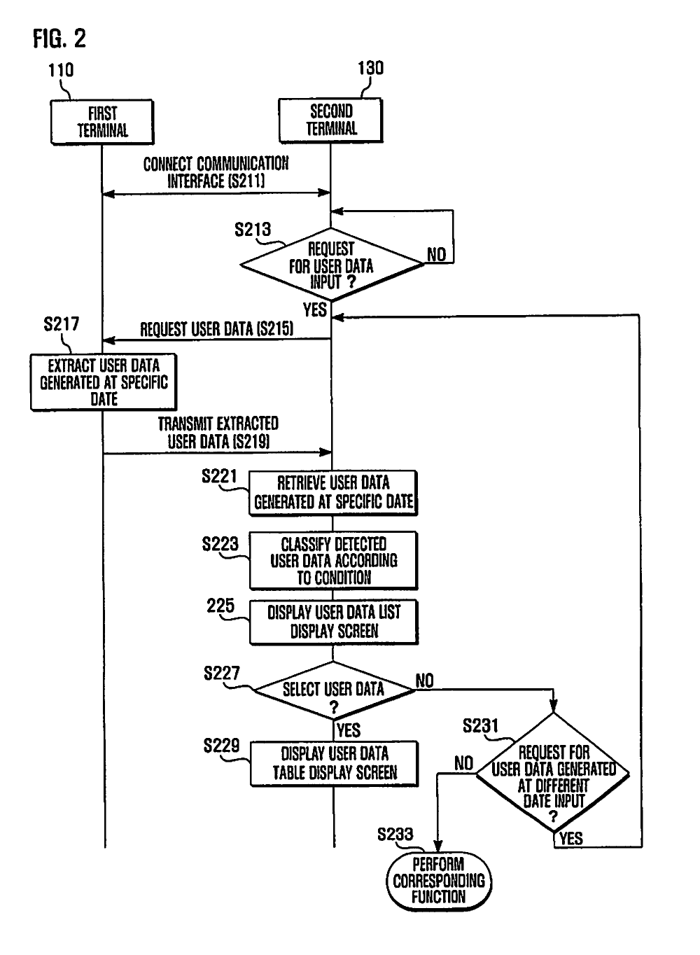

FIG. 2 is a flowchart illustrating a method of managing user data according to an embodiment of the present invention.

In the present embodiment, the first terminal 110 and the second terminal 130 are connected to each other, and user data of the first terminal 110 are displayed in the second terminal 130.

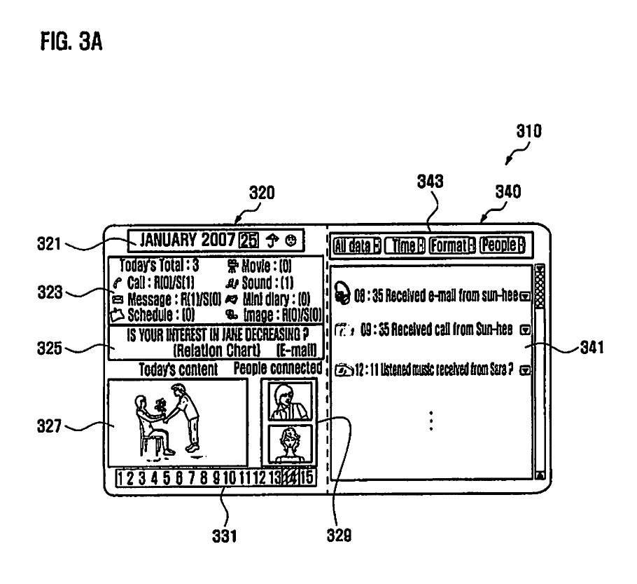

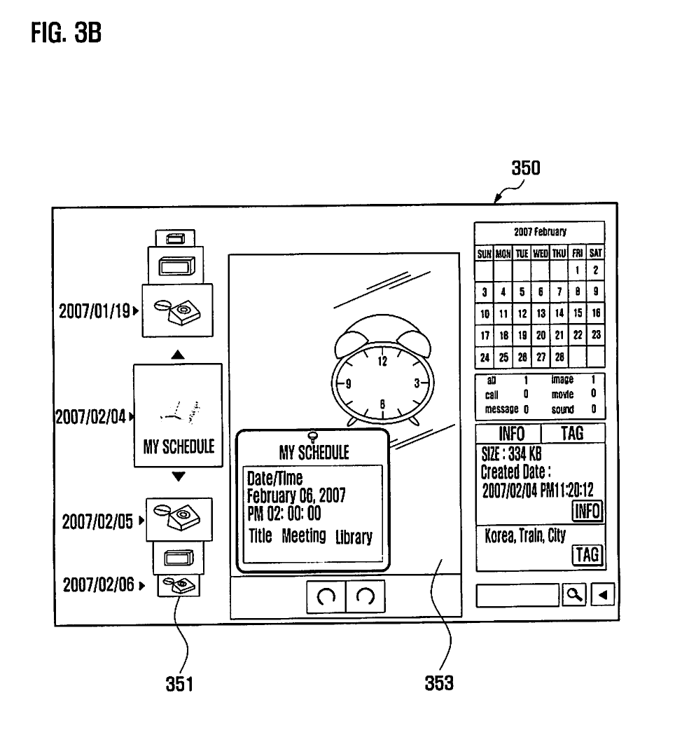

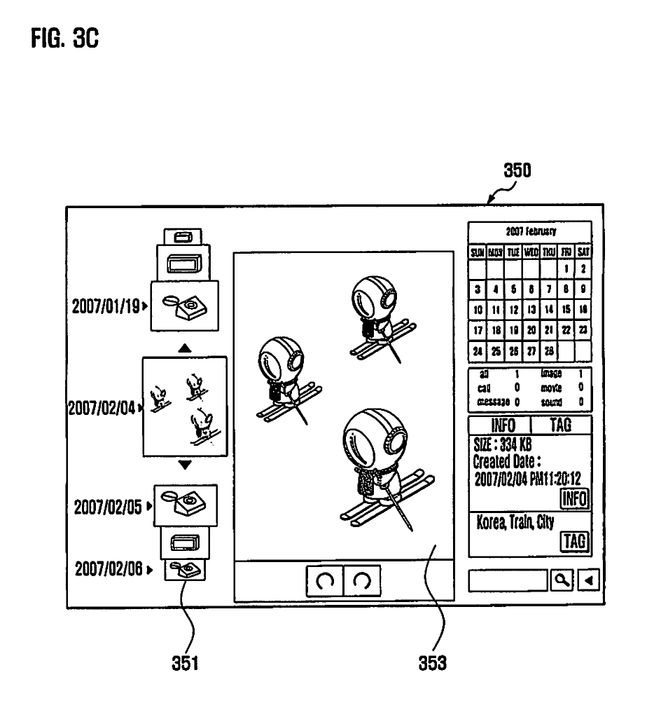

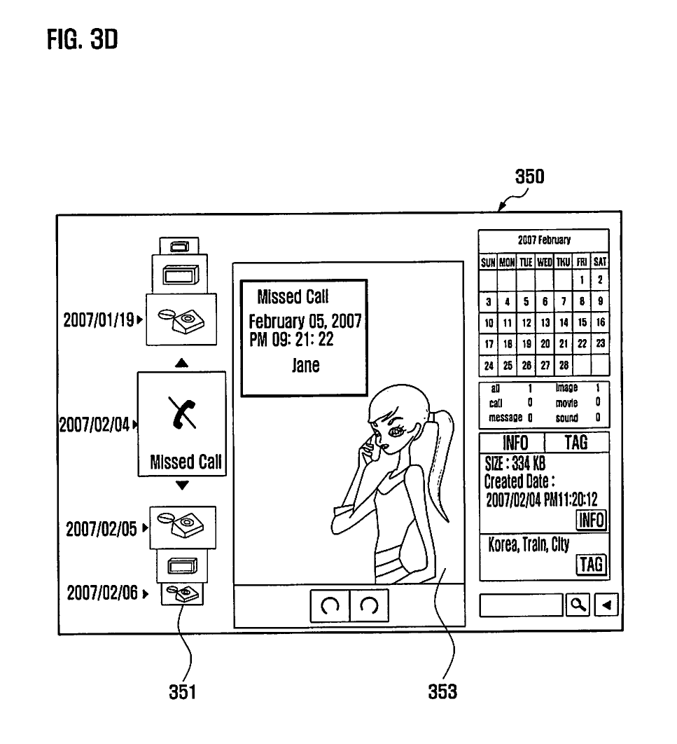

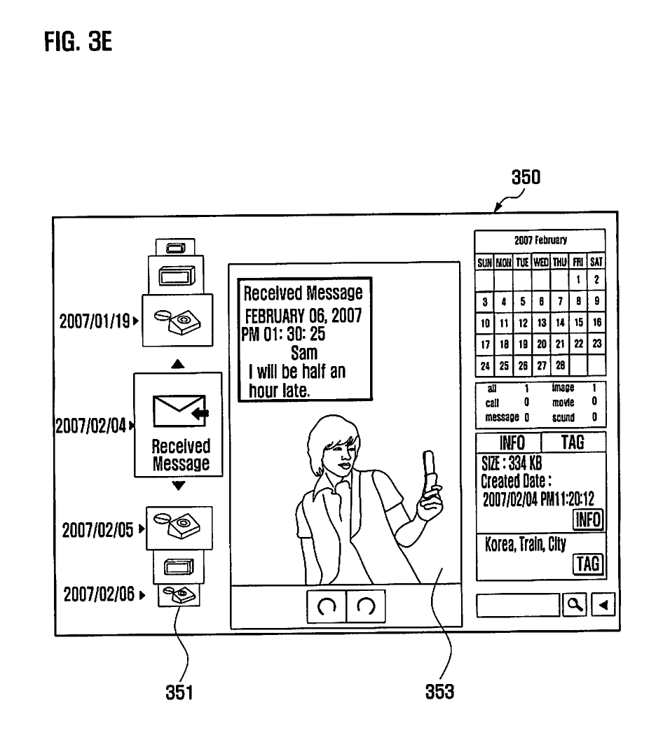

FIGS. 3A to 3E are examples of screens displayed upon performing the method of FIG. 2. FIG. 3A is an example of a user data list display screen, and FIGS. 3B to 3E are examples of user data table display screens.

Referring to FIG. 2, in the method of managing user data, the first terminal 110 and the second terminal 130 are connected to each other through the communication interfaces 121 and 141 in step S211.

The second controller 135 determines whether a request for user data is input in the second terminal 130 in step S213. If a request for user data is input in the second terminal 130, the second controller 135 sends a request for user data to the first terminal 110 in step S215. The second controller 135 checks a specific date and sends a request for user data generated at the specific date to the first terminal 110 through the second communication interface 141. The user data may be data sent to or received in the first terminal 110 through the RF unit 111 or data set by a user in the first terminal 110.

The first controller 115 extracts user data, generated at the specific date, requested by the second terminal 130 from the first memory unit 113 in step S217. That is, the first controller 115 extracts user data generated at the specific date among user data stored in the first memory unit 113. The first controller 115 transmits the extracted user data to the second terminal 130 through the first communication interface 121 in step S219.

The second controller 135 retrieves the user data received from the first terminal 110 in step S221. The second controller 135 classifies the retrieved user data according to a plurality of conditions in step S223. The second controller 135 classifies the retrieved user data according to both other party related to each user data and a data item of each user data. Further, the second controller 135 classifies the retrieved user data according to a generation timepoint of each user data. The second controller 135 also classifies the retrieved user data into user data that includes an image and user data that do not include an image.

The second controller 135 controls the second display unit 137 to display on a user data list display screen 310 according to the classification result at steps S223 and S225, as shown in FIG. 3A. The user data list display screen 310 includes a first display area 320 and a second display area 340.

The first display area 320 includes a date information display window 321, an item display window 323, a human relationship information display window 325, an image display window 327, other party display window 329, and a calendar display window 331.

The second controller 135 displays the specific date at which all of the user data of a user data list are generated on the date information display window 321. The second controller 135 further displays an icon for displaying the weather conditions of the corresponding date and an icon for displaying how the user felt on the date information display window 321. The second controller 135 can change an icon for displaying the weather and user feeling according to a request of the user of the second terminal 130.

The second controller 135 displays data items corresponding to each user data in a list on the item display window 323. The second controller 135 displays data items such as a call, message, image, schedule, and diary in the list of data items on the item display window 323. The second controller 135 counts user data corresponding to each data item and then further displays a count value of user data corresponding to each data item.

The second controller 135 displays human relationship information of an other party for each user data on the human relationship information display window 325.

The second controller 135 displays user data including an image on the image display window 327. The second controller 135 may control to display each image of user data on the image display window 327 in a slide show. The second controller 135 may control to display an image of specific user data, and then sequentially display another image according to a request of the user of the second terminal 130.

The second controller 135 displays an image for other party that is related to each user data in a list on the other party display window 329. The second controller 135 may control to display the other party in a thumbnail image registered to correspond to each other party. The second controller 135 counts user data related to each other party and then determines an order of the other parties in an increasing order of a user data count value. Thereafter, the second controller 135 displays a preset number of other parties in a predetermined order. Further, the second controller 135 displays a next other party sequentially in the predetermined order according to a request of the user of the second terminal 130. In this case, an other party performs communication of user data with the first terminal 110 and other party registered by the user upon setting user data in the first terminal 110.

Further, the second controller 135 displays a calendar including the date of the date information display window 321 on the calendar display window 331.

The second display area 340 includes a generation timepoint display window 341 and an alignment information display window 343.

That is, the second controller 135 displays a generation timepoint of each user data in a list on the generation timepoint display window 341. The second controller 135 further displays the user data corresponding to each generation timepoint on the generation timepoint display window 341. The second controller 135 displays alignment information for reclassifying user data listed on the generation timepoint display window 341 on the alignment information display window 343. The second controller 135 changes alignment operation according to a user selection of the alignment information display window 343. The second controller 135 can realign user data on the generation timepoint display window 341 according to additional user selection of the alignment information display window 343.

While the user data list display screen 310 displays, the second controller 135 determines whether user data are selected from one of the display windows in step S227. If user data are selected, the second controller 135 displays a user data table display screen 350 on the second display unit 137 in step S229, as shown in FIGS. 3B to 3E. The user data table display screen 350 includes a user data table 351 and a data display window 353. The second controller 135 aligns information of user data in a generation timepoint order of each user data in the user data table 351. In the screen examples shown, the second controller 135 can align information of user data in the user data table 351 in a wheel form. That is, the second controller 135 can align an icon for displaying information of user data and a generation timepoint corresponding to information adjacent to each other on a virtual wheel. The second controller 135 can rotate the virtual wheel according to a request of the user of the second terminal 130. Further, if information is selected in the user data table 351, the second controller 135 displays a detailed corresponding content of the selected information on the data display window 353.

For example, if an item is selected as user data on the item display window 323 at step S227, the second controller 135 aligns information of user data corresponding to the selected item in the user data table 351, as shown in FIG. 3B. If an image is selected on the image display window 327, the second controller 135 aligns information of user data having an image in the user data table 351, as shown in FIG. 3C. If an other party is selected on the other party display window 329, the second controller 135 aligns information of user data related to the selected other party, as shown in FIGS. 3D and 3E.

If user data are not selected at step S227, the second controller 135 determines whether a request for user data generated at a different date is input in step S231. If a request for user data generated at a different date is input, the process returns to step S215, and the user of the second terminal 130 selects a specific date on the calendar display window 331 and checks user data generated on the specific date.

If a request for user data generated at a different date is not input at step S231, the second controller 135 performs a corresponding function in step S233.

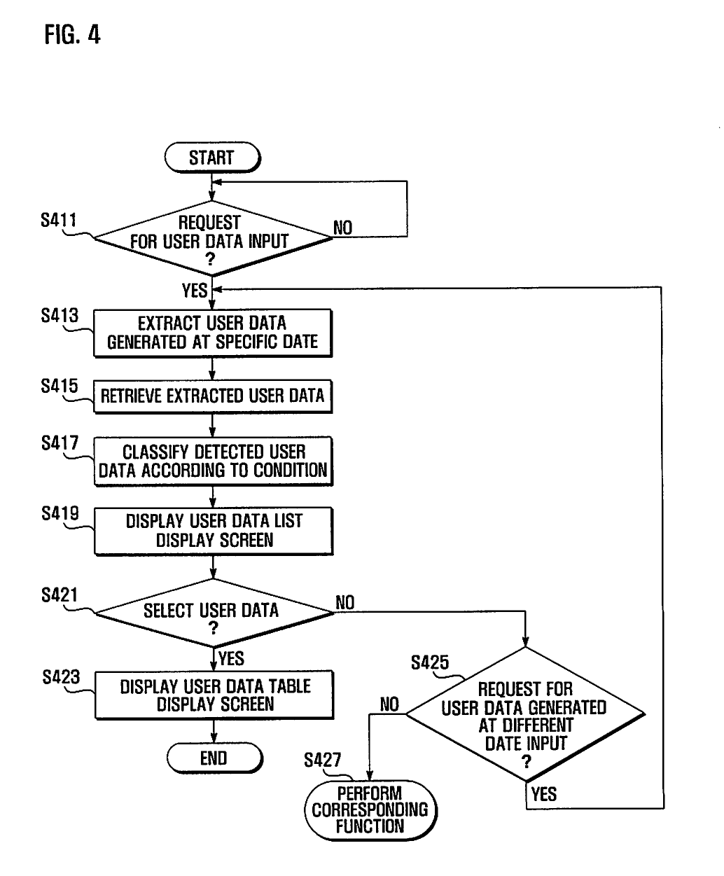

FIG. 4 is a flowchart illustrating another method of managing user data according to another embodiment of the present invention.

In the present embodiment, user data are displayed in the first terminal 110.

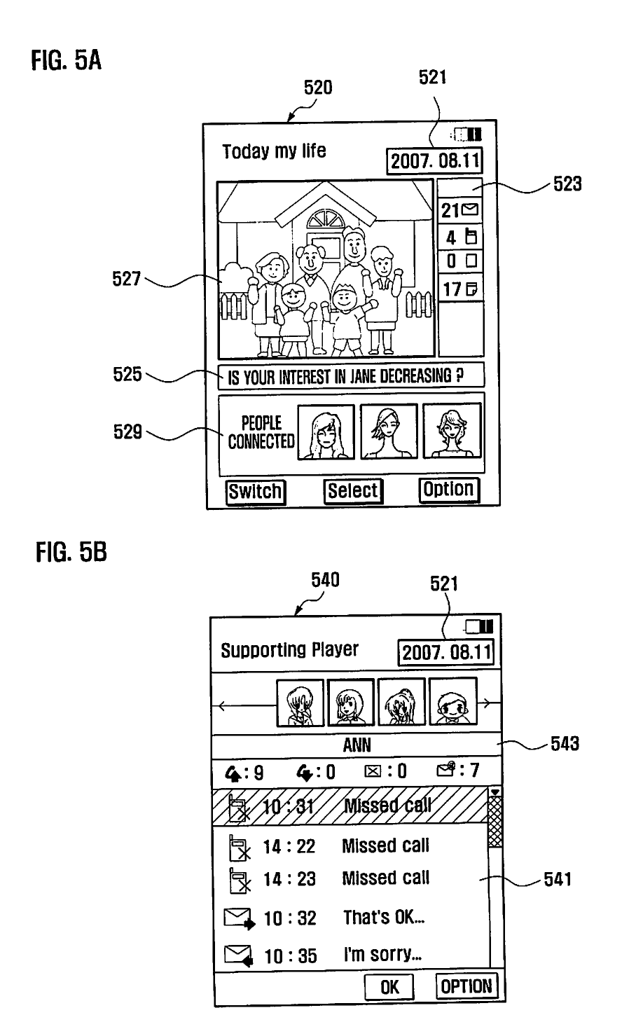

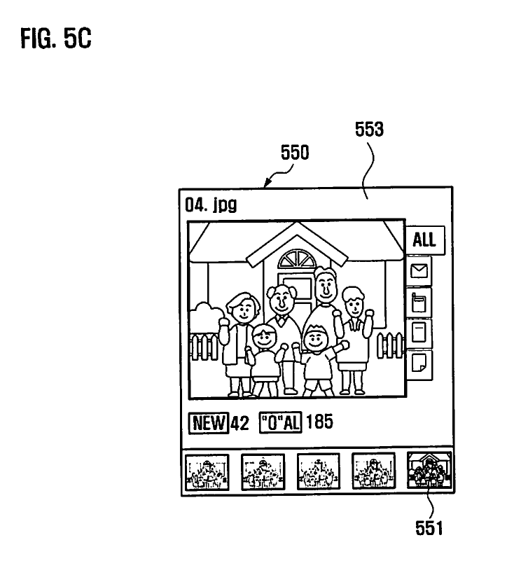

FIGS. 5A to 5C are examples of screens displayed with the method of FIG. 4. FIGS. 5A and 5B are examples of user data list display screens, and FIG. 5C is an example of a user data table display screen.

Referring to FIG. 4, the first controller 115 determines whether a request for user data is input in step S411. If a request for user data is input, the first controller 115 extracts user data generated at a specific date from the first memory unit 113 in step S413. That is, the first controller 115 checks a specific date and extracts user data generated at the specific date from the first memory unit 113.

The first controller 115 retrieves the extracted user data in step S415.

The first controller 115 classifies the retrieved user data according to a condition in step S417. The first controller 115 classifies the retrieved user data according to both an other party related to each user data and a data item of each user data. Further, the first controller 115 classifies the retrieved user data according to a generation timepoint of each user data. The first controller 115 also classifies the retrieved user data into user data having an image and user data not having an image.

The first controller 115 displays a first user data list display screen 520 and a second user data list display screen 540 on the first display unit 117 according to the classification result at steps S417 and S419, as shown in FIGS. 5A and 5B. That is, the first controller 115 displays one of the first user data list display screen 520 and the second user data list display screen 540 according to a request of the user of the first terminal 110, and may repeatedly perform an operation of alternatively displaying the first and second user data list display screens 520 and 540. The first user data list display screen 520 includes a date information display window 521, an item display window 523, a human relationship information display window 525, an image display window 527, and other party display window 529. The second user data list display screen 540 includes a generation timepoint display window 541 and an alignment information display window 543.

While the first and second user data list display screens 520 and 540 displays, the first controller 115 determines whether user data are selected in step S421. If user data are selected, the first controller 115 controls the first display unit 117 to display a user data table display screen 550 in step S423, as shown in FIG. 5C. The user data table display screen 550 includes a user data table 551 and a data display window 553.

If user data are not selected at step S421, the first controller 115 determines whether a request for user data generated at a different date is input in step S425. If a request for user data generated at a different date is input, the process returns to step S413 and the user selects a specific date and checks data generated on the specific date.

If a request for user data generated at a different date is not input at step S413, the first controller 115 performs a corresponding function in step S427.

In the present embodiment, in describing the first and second user data list display screens 520 and 540 and the user data table display screen 550, a basic structure of each of the first and second user data list display screens 520 and 540 is similar to a basic structure of the user data list display screen 310 of the previous embodiment, and a basic structure of the user data table display screen 550 is similar to a basic structure of the user data table display screen 350 of the previous embodiment, and therefore a detailed description thereof is omitted.

As described above, in a method of managing user data in a communication terminal according to embodiments of the present invention, when display of user data is requested in the communication terminal, user data generated at a specific date are retrieved and classified according to at least two conditions, and a plurality of user data lists are displayed on a plurality of display windows on a screen. Therefore, a user of a communication terminal can check user data generated in units of a day, and can easily search for user data in a user data list classified according to various conditions.

While the invention has been shown and described with reference to a certain preferred embodiment thereof, it should be clearly understood that many variations and modifications of the basic inventive concepts herein taught which may appear to those skilled in the present art will still fall within the spirit and scope of the present invention, as defined by the appended claims.

What is claimed is:

1. A method of managing user data in a communication terminal, comprising:
retrieving, when a request for displaying user data is input, user data generated at a specific date;
classifying the retrieved user data in accordance with multiple associated conditions; and
displaying a plurality of user data lists for displaying the classified user data on a plurality of display windows or a plurality of parts of a display window on a screen.

2. The method of claim 1, further comprising displaying, if user data are selected among the display windows, the selected user data in a user data table.

3. The method of claim 1, further comprising classifying the user data according to an other party related to each user data.

4. The method of claim 3, further comprising classifying the user data according to a data item corresponding to each user data.

5. The method of claim 3, further comprising classifying the user data according to a sequential generation timepoint of each user data.

6. The method of claim 3, further comprising classifying the user data according to whether the user data comprises an image.

7. The method of claim 3, wherein displaying the plurality of user data lists comprises displaying an other party in an increasing order of quantity of the user data related to each other party.

8. The method of claim 7, wherein displaying the plurality of user data lists further comprises displaying a thumbnail registered to correspond to other party.

9. The method of claim 4, wherein displaying the plurality of user data lists comprises both displaying a list of the data items and a count value of the user data corresponding to each data item.

10. The method of claim 5, wherein displaying the plurality of user data lists comprises displaying the user data in a time order of generation timepoint.

11. The method of claim 6, wherein displaying the plurality of user data lists comprises displaying an image corresponding to each user data in a slide show.

12. A method of managing user data in a communication terminal, comprising:
retrieving, when a request for displaying user data is input, user data generated at a specific date;
classifying the retrieved user data according to an other party related to each user data, a data item corresponding to each user data, and a sequential timepoint at which each user data is generated; and
displaying a list of other parties on a first display window, displaying a list of data items on a second display window, and displaying the user data on a third display window in a time order of generation timepoint.

13. The method of claim 12, further comprising displaying, if an other party is selected on the first display window, the user data related to the selected other party in a user data table.

14. The method of claim 13, wherein displaying the list of other parties on a first display window comprises displaying the other parties in an increasing order of quantity of the user data related to each other party.

15. The method of claim 14, wherein the displayed list of other parties comprises a list of thumbnails registered to correspond to each other party.

16. The method of claim 12, further comprising displaying, if an item is selected on the second display window, the user data corresponding to the selected item in a user data table.

17. The method of claim 16, wherein displaying the item list on a second display window comprises displaying a count value of the user data corresponding to each of the items.

18. The method of claim 12, further comprising classifying the user data according to whether the user data comprises an image.

19. The method of claim 18, further comprising displaying an image corresponding to each user data on a fourth display window in a slide show.
